(19) United States
(12) Patent Application Publication
(10) Pub. No.: US 2009/0038206 A1
(43) Pub. Date: Feb. 12, 2009

(54) KNOTS FOR LINKING TWO PARALLEL LINES, METHOD OF PRODUCING AND PRE-ASSEMBLING A NET, SUCH AS A FISHING NET, AND FISHING NET THUS PRODUCED

(75) Inventor: Jean-Bernard Conte, Plouezec (FR)

Correspondence Address: Young & Thompson, 745 S. 23rd Street., Second Floor, Arlington, VA, 22202, US

(73) Assignee: ETABLISSEMENTS ARMAND MONDIET, Le Teich (FR)

(21) Appl. No.: 11/915,635

(22) PCT Filed: May 24, 2006
(86) PCT No.: PCT/FR2006/001216

§ 371 Date: May 8, 2008

(30) Foreign Application Priority Data
May 27, 2005 (FR) 0551397
Sep. 15, 2005 (FR) 0552781
Nov. 7, 2005 (FR) 0553362
Jan. 16, 2006 (FR) 0650134
Apr. 4, 2006 (FR) 0651189

(51) Int. Cl. A01K 75/00; B65H 69/04; D04G 1/00; D04G 5/00; A01K 71/00

(52) U.S. Cl. 43/7; 289/1.2; 29/428; 289/1.5

(57) ABSTRACT

The invention relates to a knot for linking two lines, ropes or similar, such as a float line or a ballast line and a mounting yarn having at least one netting connected thereto. The invention is characterised in that it comprises the following steps consisting in: forming a loop with the first line, said loop comprising two strands which are connected at the tip of the first loop and which separate from one another at the base of the first loop; bending the upper part of the first loop downwards and placing the lower parts of the strands between the upper parts of the strands that are connected at the tip, such as to form a second loop; forming a third loop with the lower parts of the strands under the second loop; introducing the third loop into the second loop; and separating the end of the third loop from the lower parts of the strands, such as to form the knot.

This invention relates to a knot that is able to ensure the connection between two lines that extend in parallel, more particularly suitable for ensuring the connection between one end supporting at least one mesh netting and a float or ballast line, as well as the net thus produced.

The document FR-2,682,261 describes a process for connecting mesh nettings for fishing so as to produce a fishing net that is also called “a trammel.”

According to this document, the layers are preassembled and connected to one another using an adhesive or a textile yarn. The upper meshes of this preassembly of mesh nettings are then slipped onto an assembly yarn that is itself attached to a float line, also called a bolt rope. In the same way, the lower meshes of this preassembly are slipped onto an assembly yarn that is itself attached to a ballast line. For the rest of the description below, as for the different figures, only the upper portion of the net will be described knowing that the lower portion can be made in the same way.

Such an assembly requires many hours of manual labor. To reduce the production costs, the manufacturers are increasingly seeking to outsource the majority of this assembly to areas with low manual labor costs. However, assembly on float lines and ballast lines can be done only close to the boats' home ports. Actually, the shipping of a net outfitted with float and ballast lines (optionally with one-way shipping of the lines to be outfitted) is relatively expensive and has a higher cost than that of the assembly, contrary to the mesh nettings that are light and can be shipped from one continent to the next with relatively low shipping costs.

Thus, the mesh nettings are preassembled in countries with low manual labor costs. This preassembled unit is then connected to float and ballast lines with an assembly yarn.

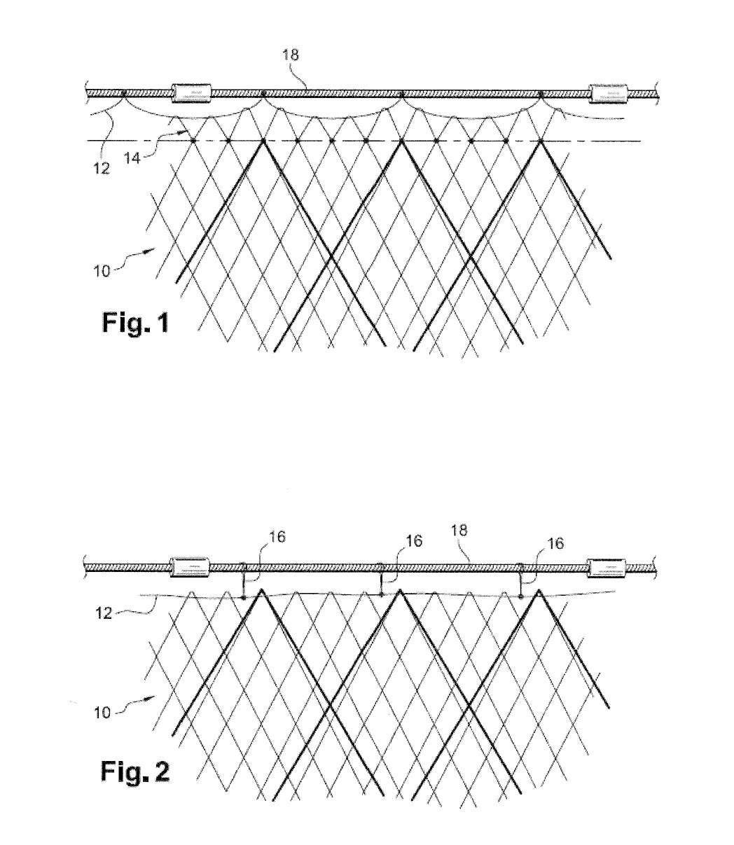

According to a first technique illustrated by FIG. 1, half-meshes 14 that also ensure the uniform remote assembly of layers of large meshes with a layer of small meshes is added to the selvage of the layers 10. Then, an assembly yarn 12 is introduced through the half-meshes 14. Other techniques could be used to connect the selvage of the layers 10 to the assembly yarn 12.

According to a technique that is illustrated by FIG. 1, the assembly yarn 12 is tapped at regular intervals on the float or ballast line 18 by isolating a given number of meshes between each line tap, in this case four according to the illustrated example, whereby the line taps are placed to the right of the junctions of the layers of small and large meshes.

Even if this technique makes it possible to keep, during use, the layers that are distributed evenly over the entire length of the float and ballast lines, it is not fully satisfactory because the preassembly and the assembly on the float lines and/or ballast lines are relatively long and therefore costly. In addition, the separation of the float lines during the change of the layers is relatively long and costly.

According to a technique that is illustrated by FIG. 2, a knot 16, such as two reversed half-hitches, is produced with the assembly yarn 12 to ensure the connection between the assembly yarn 12 and the float or ballast line 18. Thus, the assembly yarn 12 is immobilized at each of the two reversed half-hitches and does not slide relative to the float or ballast line 18. A predetermined number of meshes being isolated between two consecutive knots 16, said knots 16 make it possible to obtain an even distribution of the layers over the length of the float or ballast line 18.

Even if this technique makes quick assembly and mounting possible, it is not satisfactory because these knots can slide, which can interfere with the distribution of the meshes along the float line or the ballast line.

Also, this invention aims at eliminating the drawbacks of the prior art by proposing a knot that makes it possible to ensure the connection between an assembly yarn and a float or ballast line and more generally between two lines that extend in parallel.

For this purpose, the object of the invention is a knot that can ensure a connection between two lines, ropes or the like, in particular a float or ballast line, and an assembly yarn to which is connected at least one mesh netting, characterized in that it consists in:
Forming at the level of a line a first loop that comprises two segments that are connected at the tip of said first loop and are separated at the foot of the first loop,
Bending the upper portion of the first loop back and down and placing the lower portions of the segments between the upper portions of the segments that are connected to the tip so as to form a second loop,
Forming a third loop with the lower portions of the segments under the second loop,
Introducing the third loop into the second loop,
Separating the end of the third loop and the lower portions of the segments so as to form said knot.

This invention also proposes a process for the production or preassembly of a net, in particular a fishing net, using said knot.

Other characteristics and advantages will emerge from the following description of the invention, a description that is given only by way of example, with regard to the accompanying drawings, in which:

FIG. 1 is a diagrammatic view illustrating a first assembly technique according to the prior art,

FIG. 2 is a diagrammatic view illustrating another assembly technique according to the prior art,

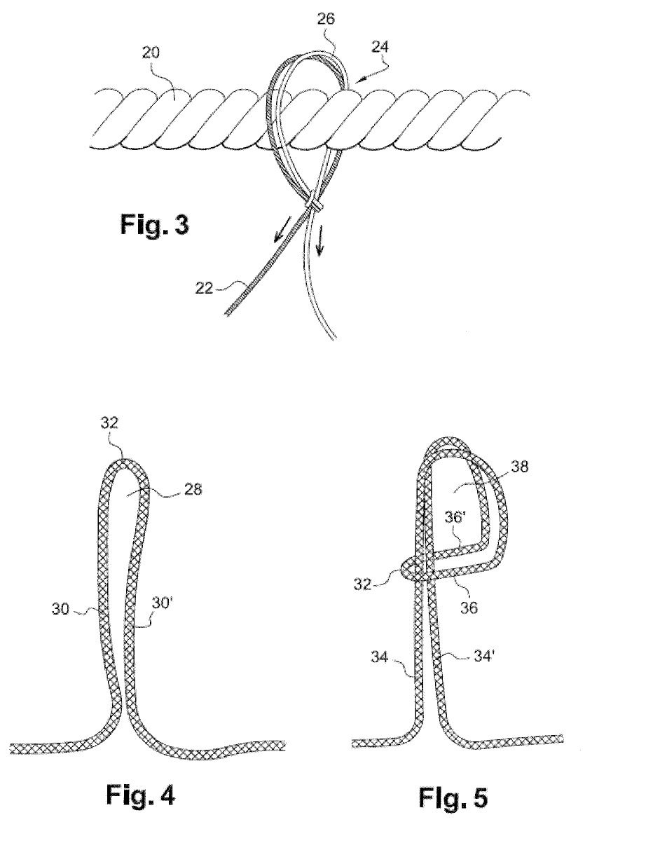

FIG. 3 is a perspective view illustrating a knot according to the invention that is made on a first line that forms a sliding loop into which another line passes,

FIGS. 4 to 7 diagrammatically illustrate the various stages for the production of a knot according to the invention,

FIG. 8 is a representation of a net that uses said knot according to a first assembly method,

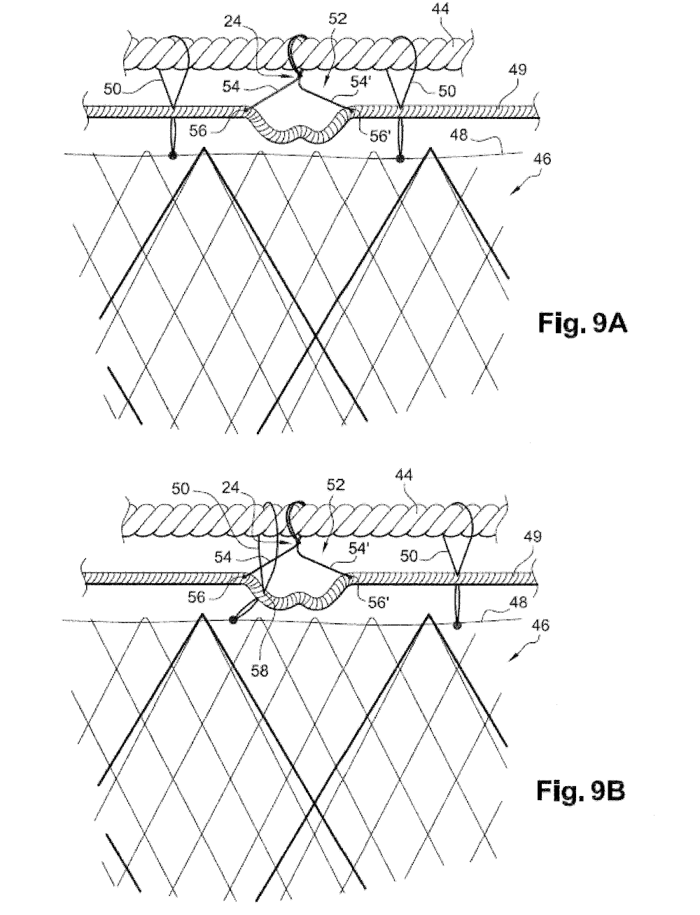

FIG. 9A is a representation of a net using said knot according to another assembly method,

FIG. 9B is a representation of a net using said knot according to another assembly method,

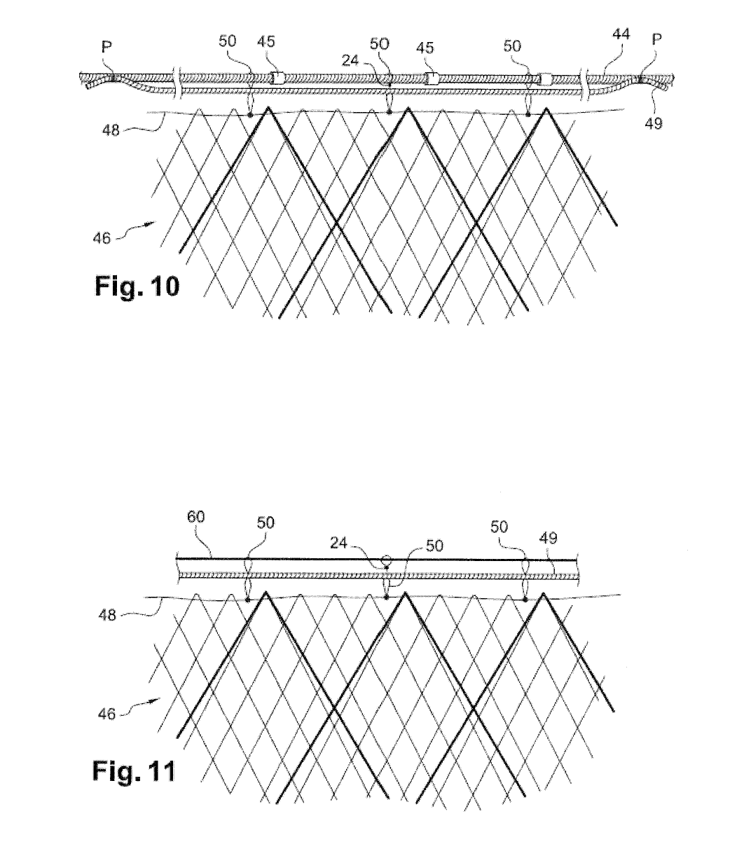

FIG. 10 is a diagrammatic view that illustrates a preassembled unit according to a variant of the invention, after mounting on a float or ballast line,

FIGS. 11 to 13 are diagrammatic views that illustrate the various stages of the assembly of a preassembled net and a float or ballast line to produce the assembly of FIG. 10,

FIG. 14 is a view that illustrates with details a loop that passes through a distribution line,

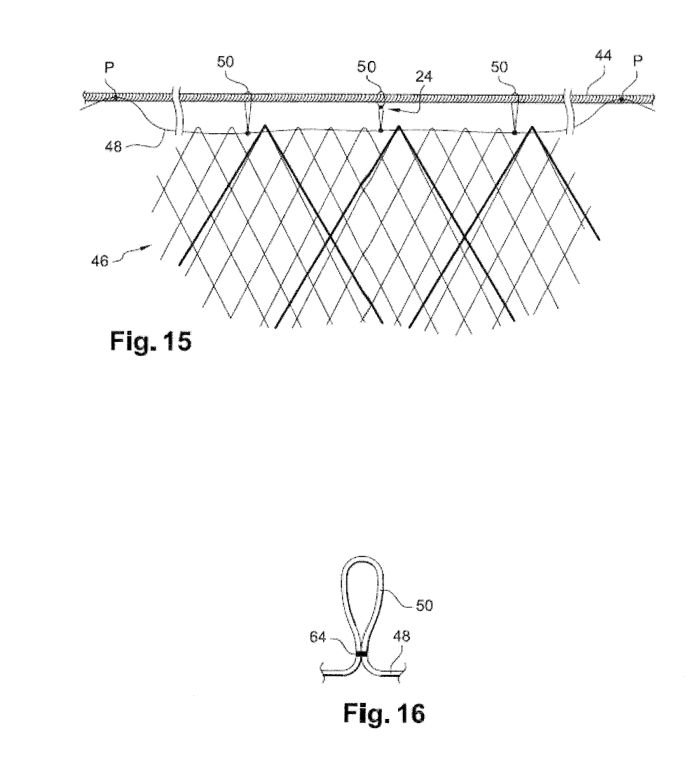

FIG. 15 is a diagrammatic view that illustrates a preassembled unit according to another variant of the invention, after mounting on a float or ballast line, and

FIG. 16 is a view that illustrates with details a loop according to an embodiment.

FIG. 3 shows a first line 20 and a second line 22, whereby said lines 20 and 22 are connected by a knot 24.

Line is defined as all types of ropes, in particular lines, ends, yarns, segments, cables, etc., that can be stranded or braided, or be interlaced, intertwined, reeled in, etc. The lines 20 and 22 can be made from various materials. According to the variants, the lines 20 or 22 can have different diameters.

According to a sample application, the first line 20 could be a float or ballast line, and the second line 22 could be an assembly yarn to which would be connected at least one mesh netting so as to constitute a fishing net.

The knot 24 is of the sliding type, and it comprises a loop 26 that is formed from one line, according to the example the second line 22, whose opening dimensions are able to vary so as to encircle and to be immobilized relative to the other line, according to the example the first line 20.

According to the invention, the knot 24 is made in the following way:

As illustrated in FIG. 4, starting from one of the lines, a loop 28 that comprises two segments 30, 30′ that are connected to the tip 32 of the loop 28 and that separate at the foot of the loop 28 is formed.

As illustrated in FIG. 5, the upper portion of the loop 28 is bent back and down, and the lower portions 34, 34′ of the segments are placed between the upper portions 36, 36′ of the segments that are connected to the tip 32 so as to form a loop 38.

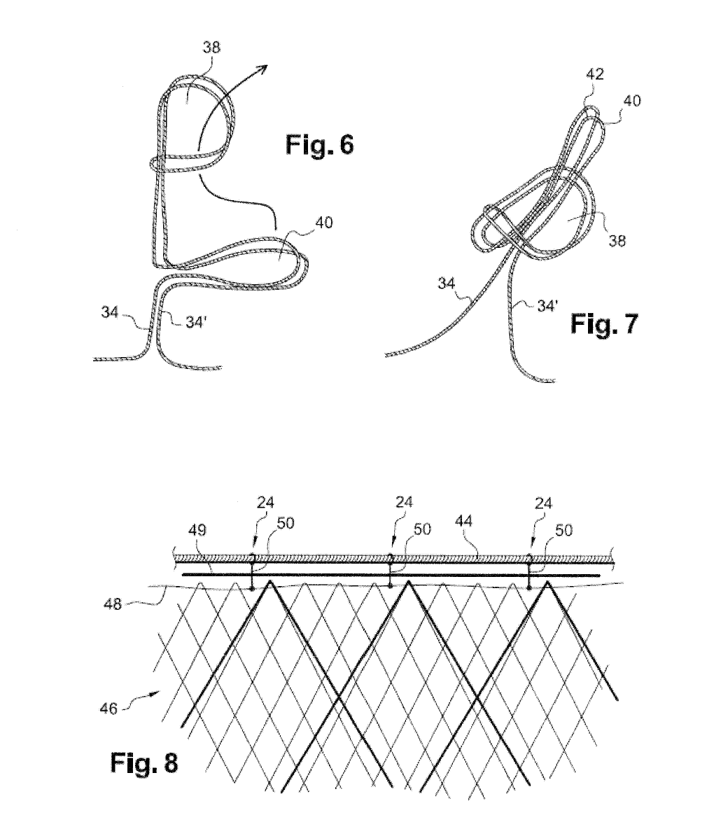

As illustrated in FIG. 6, a loop 40 is formed with the lower portions 34, 34′ of the segments under the loop 38.

This loop 40 is introduced into the loop 38, as illustrated in FIG. 7.

By separating the end 42 of the loop 40 and the lower portions 34, 34′ of the segments, a knot as illustrated in FIG. 3 is produced.

Preferably, a number of knots 24 each with a loop 40 are made at a second line, whereby the knots 24 are separated by a predetermined distance and isolate a predetermined number of meshes from the mesh netting or nettings.

All of the loops 40 are slipped on and distributed over a first line, and then the knots are tightened so as to become immobilized with a given distribution and to no longer slide over said first line.

According to an assembly technique, the loops 40 of the knots 24 can be slipped onto a rigid or flexible tube, and then transferred over a line, when this line is slipped into the tube and pulled. However, other technical solutions can be considered.

According to the invention, this knot allows a quick assembly due to the presence of a sliding loop 40.

However, thanks to its design, when it is tightened and immobilized at a given position, this knot is immobilized on the line onto which it is slipped, which makes it possible to preserve an even distribution of the knots 24 along said line.

FIGS. 8, 9A, 9B, 10 and 15 show a net that comprises at least one layer 46. Advantageously, the net comprises three layers with different mesh dimensions. The embodiment of the layers as well as their shapes and natures are not presented in more detail because they are known to one skilled in the art.

The layer or layers 46 is (are) slipped onto one end 48 or connected to an end 48. End is defined as all types of braids, yarns with strands, or the like. For the rest of the description, the end 48 is called assembly yarn.

As above, various techniques can be used to ensure the connection between the layer or layers 46 and the assembly yarn 48. According to the variants, the layer or layers are slipped directly onto the assembly yarn. According to another variant, a half-mesh can be added at the edge of the layers, as illustrated in FIG. 1. As a variant, the layer or layers could be slipped onto a first assembly yarn, which is itself attached to a second assembly yarn. The connection between the layer or layers and the assembly yarn is not presented in more detail because it is known to one skilled in the art.

To operate, the net should be connected to at least one float and/or ballast line 44. For the rest of the description, only the connection between the preassembly and the float line will be described. It is possible to use this type of connection or another, as appropriate, to connect the preassembly and the ballast line that is not shown in the figures.

According to the invention, to connect the layer or layers 46 to the float or ballast line 44, loops 50 are formed at the assembly yarn 48, isolating a given number of meshes between two successive loops 50, and are slipped onto the float or ballast line 44. The loops have suitable dimensions for sliding freely over the float or ballast line 44 despite the floats 45 or the ballasts. Other solutions can be considered to ensure the connection between an assembly yarn and the float line.

According to the variants, the distance to the assembly yarn 48 that separates two loops 50 and/or the number of meshes isolated between two consecutive loops can vary.

According to an assembly variant that is illustrated in particular in FIG. 10 to ensure an even distribution of the meshes over the entire length of the float and/or ballast line 44, the net comprises a distribution yarn 49, preferably connected at least to each of the ends of the float or ballast line 44 by any suitable means (points P), whereby at least some loops 50—and preferably all—pass through said distribution yarn 49 at regular intervals.

The distribution yarn 49 is an assembly of at least two yarns, segments, cables or the like that can be stranded, braided, interlaced, intertwined, reeled in, etc. In addition, these strands, yarns, segments, cables or the like can be made from different materials.

The distribution yarn 49 is preferably braided as illustrated in FIG. 14, whereby passage openings 58 are made between the segments of said distribution yarn at approximately regular intervals to allow the meshes or loops of the assembly yarn to pass, unlike a distribution yarn, which has strands for which the locations of the passage openings 58 may vary.

As a variant as illustrated in FIG. 15, the net does not comprise any distribution yarn 49. In this case, the assembly yarn 48 is connected to the float or ballast line 44, by any suitable means, at points P on both sides of the layer or layers 46. According to this assembly, the length of the assembly yarn 48 between the points P is slightly greater than the length of the float or ballast line 44 between said points P.

Thus, the assembly yarn 48 that is connected on both sides of the layer or layers 46 ensures the distribution of the layers over the entire length of the float or ballast line 44 between the points P, whereby the loops 50 can slide freely over the float or ballast line 44.

So that the mesh netting or nettings 46 are distributed evenly over the length of the float line 44, a knot 24 is formed at least one loop 50, as illustrated in FIGS. 8 and 10. This configuration makes it possible to limit the sliding of the layers along the float line.

According to another variant that is illustrated in FIGS. 9A and 9B, at least one link 52 is inserted between the float line 44 and the assembly yarn 48 or the distribution line 49. This link 52 comprises a knot 24 according to the invention whose tightening loop encircles the float line 44, whereby said knot defines two segments 54, 54′, whereby at least one of the two segments is connected to the assembly yarn 48 or the distribution line 49. Advantageously, the ends of the two segments 54, 54′ are connected to the distribution line 49 or to the assembly yarn 48 at points 56, 56′ as illustrated in FIGS. 9A and 9B.

As illustrated in FIG. 9B, one of the segments 54 or 54′ can pass through a loop 56. When a distribution line 49 is present, the opening that is made in the distribution line 49 to allow the passage of the loop 50 is provided between the points 56 and 56′. In the absence of distribution yarn, the point of connection between the loop 50 and the assembly yarn 48 is placed between the points 56 and 56′. This configuration makes it possible to limit the travel of the loops 50. The connection between the ends of the segments 54, 54′ and the distribution line 49 can be produced by any means, in particular by interlacing segments and the distribution line 49 by at least one knot, by tapping, etc.

According to another characteristic of the invention, the sum of the lengths of the two segments 54, 54′ is less than the length of the distribution line or the assembly yarn between the points 56, 56′. This configuration makes it possible to tighten the knot 24 automatically when tension is exerted on the distribution line.

As a variant, the knot 24 could be formed on the distribution line and the segments 54, 54′ that are connected to the float line.

As a variant, the assembly yarn could be substituted with the distribution line.

Preferably, the knots 24 are distributed evenly over the length of the assembly yarn, the distribution line or the float or ballast line. The preassembly of the layers 46 with the assembly yarn and optionally the distribution yarn 49 is advantageously produced in countries with low manual labor costs. Advantageously, the loops 50 of the assembly yarn 48 are slipped onto a yarn 60 that is also called a cable-puller, as illustrated in FIG. 11. The presence of a cable-puller 60 facilitates the subsequent assembly of the float or ballast lines 44 and makes it possible to preserve a compact and light preassembly that tends to reduce the shipping costs.

To connect the preassembly and the float line 44, the loops 50 of the assembly yarn 48 are slipped onto the float or ballast line 44.

Whereby the assembly yarn 48 extends along the float or ballast line 44 and isolates a net portion or a given number of meshes between each loop 50, for example four meshes, said net is distributed evenly along the float or ballast line 44.

According to the variants, so that the distribution yarn 49 extends over the entire length of the float or ballast line 44, the distribution line 49 is connected at points P on both sides of layers 46 at each end of the float or ballast line 44, whereby the distribution yarn has a length that is slightly longer than that of the float or ballast line 44.

According to other variants, so that the assembly yarn 48 extends over the entire length of the float or ballast line 44, the assembly yarn 48 is connected at points P on both sides of the layers 46, at each end of the float or ballast line 44, whereby the assembly yarn 48 has a length that is slightly longer than that of the float or ballast line 44.

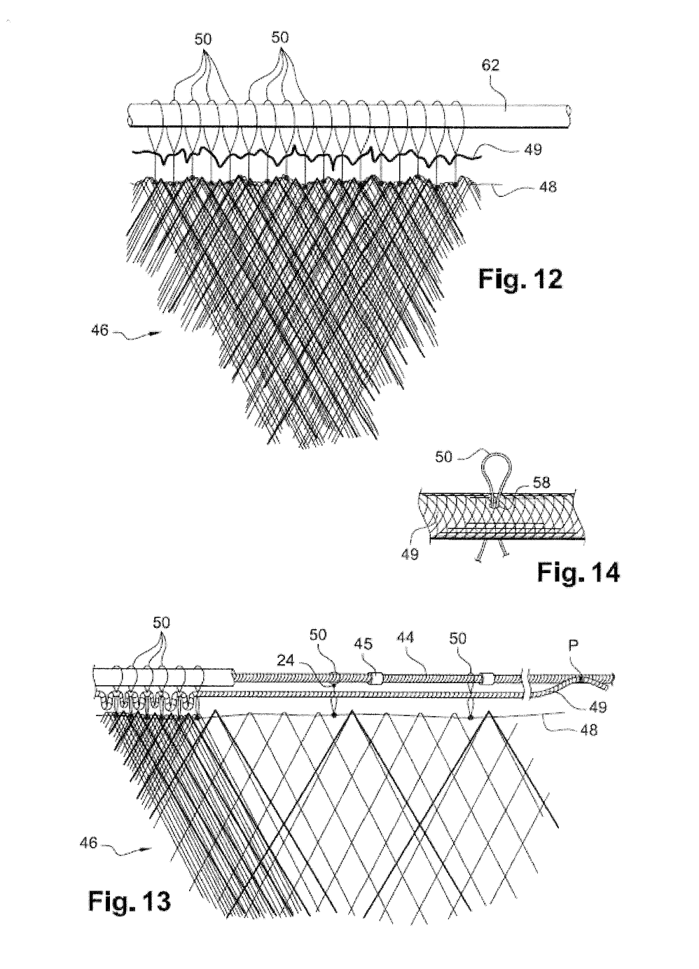

According to one implementation, to connect the preassembly to the float or ballast lines, it is possible to use an assembly tube 62 in countries with high manual labor costs. This tube 62 is not necessary for shipping as in the prior art.

Whereby the preassembly comprises a cable-puller 60 as illustrated in FIG. 11, the operator can slip the loops 50 of the assembly yarn onto a tube 62 by connecting said tube to the cable-puller and then by pulling on the latter so as to produce the arrangement that is described in FIG. 12.

Next, the operator runs the float or ballast line 44 into the tube 62 and connects a first end of the float or ballast line 44 to the other end of the tube at a first end of the assembly or distribution yarn, as appropriate. As illustrated in FIG. 13, by pulling on the first end of the float line 44 or the assembly or distribution yarn 32, the loops 50 of the assembly yarn are distributed along the float or ballast line 44. When the entire float or ballast line 44 is passed through the tube 62 or when the assembly or distribution yarn is extended along the float or ballast line 44, the operator connects the second end of the assembly or distribution yarn to the float or ballast line 44.

However, other solutions could be conceivable for slipping on the float or ballast line 44 in the loops 50 of the assembly yarn.

According to another implementation to connect the preassembly to the float or ballast lines, the loops 50 can be slipped onto the end of a float or ballast line 44. Then, this end of the float or ballast line is connected to a first end of the assembly or distribution yarn. By pulling on the first end of the float line 26 or the assembly or distribution yarn, the loops 50 of the assembly yarn are distributed along the float or ballast line 44. Whereby the assembly or distribution yarn is extended along the float or ballast line 44, the operator connects the second end of the assembly or distribution yarn to the float or ballast line 44.

According to the invention, a quick and simple assembly of the float and ballast lines is produced, which contributes to reducing the costs.

According to the variants, the assembly of the preassembly can be carried out in an area with low manual labor costs. In this case, the preassembly comprises the layer or layers, at least one distribution yarn, the assembly yarn or yarns (one for the float line and/or one for the ballast line) and preferably a cable-puller 60.

According to the variants, each loop 50 is produced by making a knot with the assembly yarn so as to form said loop. This solution, however, has the drawback of allowing variations of the length of the assembly yarn 48 between two loops 50 because the intensity of tightening the knot forming the loop 50 can vary.

According to a preferred embodiment that is illustrated in FIG. 16, each loop 50 is formed by making a tap 64 that connects two points to the origin that are located away from the assembly yarn 48. This solution makes it possible to have a constant distance between two loops 50, which contributes to obtaining a better distribution of the layers relative to the float and/or ballast line.

Of course, the invention obviously is not limited to the embodiment shown and described above, but on the contrary covers all its variants, in particular those that relate to nature, the dimensions of the lines, as well as the application.

According to simplified variants, the assemblies that are illustrated in FIGS. 10 and 15 might not comprise a knot 24.

1. Knot that can ensure a connection between two lines, ropes or the like, in particular a float or ballast line, and an assembly yarn to which is connected at least one mesh netting, characterized in that it consists in:
Forming at the level of a first line (22) a first loop (28) that comprises two segments (30, 30′) that are connected at the tip (32) of said first loop (28) and are separated at the foot of the first loop (28),
Bending the upper portion of the first loop (28) back and down and placing the lower portions (34, 34′) of the segments between the upper portions (36, 36′) of the strands that are connected to the tip (32) so as to form a second loop (38),
Forming a third loop (40) with the lower portions (34, 34′) of the segments under the second loop (38),
Introducing the third loop (40) into the second loop (38),
Separating the end (42) of the third loop (40) and the lower portions (34, 34′) of the segments so as to form said knot.

2. Process for ensuring a connection between two lines that consists in producing at a first line (22) a knot according to claim 1, slipping on a second line (20) in the loop that is formed by said knot, then tightening said knot so as to immobilize it on said second line.

3. Assembly of two lines (20, 22) produced from the process according to claim 2, comprising a number of knots.

4. Process for assembling a float or ballast line (44) and an assembly yarn (48) to which is connected at least one mesh netting, wherein it consists in producing a number of knots according to claim 1 at the assembly yarn (48), slipping onto the float or ballast line (44) in the loops of said knots, then tightening said knots, whereby said knots are separated on the float or ballast line by a predetermined distance.

5. Fishing net produced from the process according to claim 4.

6. Fishing net comprising at least one float line (44), preferably a ballast line, and at least one mesh netting (46) that is connected at least to the float line (44) as well as at least one knot (24) according to claim 1, making it possible to connect said at least one float line (44) and said at least one layer (46).

7. Fishing net comprising an assembly yarn (48) that ensures the connection between at least one mesh netting (46) and a float or ballast line (44), wherein it comprises at least one link (52) that comprises a knot (24) according to claim 1 whose tightening loop encircles the float or ballast line (44), whereby said knot defines two segments (54, 54′), whereby at least one of the two segments is connected to the assembly yarn (48) or to a distribution line (49) that is inserted between the assembly yarn (48) and the float or ballast line (44).

8. Fishing net according to claim 7, wherein the ends of the two segments (54, 54′) are connected to the assembly yarn (48) or the distribution line (49) at points (56, 56′), whereby the sum of the lengths of the two segments (54, 54′) is less than the length of the assembly yarn (48) or the distribution line (49) between the points (56, 56′).

9. Fishing net comprising an assembly yarn (48) that ensures the connection between at least one mesh netting (46) and a float or ballast line (44), wherein it comprises at least one link that comprises a knot (24) according to claim 1, whose tightening loop encircles the assembly yarn (48) or a distribution line (49) that is inserted between the assembly yarn (48) and the float or ballast line (44), whereby said knot defines two segments (54, 54′), whereby at least one of the two segments is connected to the float or ballast line (44).

10. Fishing net according to claim 9, wherein the ends of the two segments (54, 54′) are connected to the float or ballast line (44) at points (56, 56′), whereby the sum of the lengths of the two segments (54, 54′) is less than the length of the float or ballast line (44) between the points (56, 56′).
